(19) United States
(12) Patent Application Publication
(10) Pub. No.: US 2024/0360974 A1
(43) Pub. Date: Oct. 31, 2024

(54) LIGHTING DEVICE FOR VEHICLES

(71) Applicant: Hella GmbH & Co. KGaA, Lippstadt (DE)

(72) Inventors: Lukas Hiller, Lippstadt (DE); Carsten Hohmann, Warstein (DE); Martin Mügge, Geseke (DE)

(21) Appl. No.: 18/637,117

(22) Filed: Apr. 16, 2024

(30) Foreign Application Priority Data
Apr. 26, 2023 (DE) 102023110786.0

(51) Int. Cl. F21S 43/31; B60Q 1/00; B60Q 1/22; F21W 103/20; F21W 103/35; F21W 103/40

(52) U.S. Cl. CPC F21S 43/31; B60Q 1/0041; B60Q 1/0088; B60Q 1/22; B60Q 2400/30; F21W 2103/20; F21W 2103/35; F21W 2103/40

(57) ABSTRACT

A lighting device for vehicles includes a light source unit containing numerous light sources, and includes a hologram unit containing numerous hologram segments for generating a predefined light distribution. The hologram segments form reflection hologram segments behind and/or next to the light source unit in the main beam direction (H) of the lighting device, such that light emitted from the light source strikes the reflection hologram segment at an acute angle (φ). Holographic diffraction information is stored in the reflection hologram segments for generating a signal light distribution. The light source unit contains just one printed circuit board or one printed circuit board substrate.

### CROSS REFERENCE

This application claims priority to German Application No. 10 2023 110786.0, filed Apr. 26, 2023, the entirety of which is hereby incorporated by reference.

### FIELD OF THE INVENTION

The invention relates to a lighting device for vehicles that has a light source unit containing a number of light sources, and a hologram unit containing a number of hologram segments for generating a predefined light distribution, in which the hologram segments are reflection hologram segments behind and/or adjacent to the light source unit in the main beam direction of the lighting device, such that the light emitted from the light sources strikes the reflection hologram segments at an acute angle, and holographic information for generating a signal light distribution is stored in each of the hologram segments.

### BACKGROUND OF THE INVENTION

DE 10 2021 117 908 A1 discloses a lighting device for vehicles that has a light source unit containing numerous light sources and a hologram unit containing a number of hologram segments for generating a predefined light distribution. The hologram segments are reflection hologram segments with which light from the light sources can be deflected to a main beam direction of the lighting device. The reflection hologram segments are behind the light sources in the main beam direction. The light sources are concealed behind a horizontal screen with holes through which the light from the light sources strikes the respective hologram segments at an acute angle. The disadvantage with this lighting device is that because of the curvature of the adjacent hologram segments, the light sources must be at different directions to the hologram unit, such that it is relatively difficult to install the light sources.

### BRIEF SUMMARY OF THE INVENTION

The object of the present invention is to create a lighting device for vehicles containing numerous hologram segments for generating a predefined light distribution with which different light distributions can be easily generated, and which is much easier to install.

The particular advantage with the invention is that the light source unit is relatively simple, because it only requires a single printed circuit board or a single printed circuit board substrate.

According to a preferred embodiment of the invention, the printed circuit board can be flat and have two sides, such that it can be populated with numerous light sources on both sides. The light sources are placed on both sides of the printed circuit board, corresponding to reflection hologram segments that contain diffraction information, such that light is reflected in the same main beam direction. Because the printed circuit board is aligned with the main beam direction, the light source unit can be concealed behind a relatively small screen.

According to one aspect of the invention, the printed circuit board substrate is V-shaped, such that it not only supports the light sources, but also functions as a screen. The light sources are concealed by the sides of the printed circuit board substrate meeting at an acute angle.

According to one aspect of the invention, a partial light distribution, or the entire light distribution, is generated by reflection at overlapping reflection hologram segments. The reflection hologram segments contain the same diffraction information over their respective surfaces, such that the reflection properties, and therefore the brightnesses of the corresponding partial light distributions vary at transitions from a first reflection hologram segment to an adjacent reflection hologram segment. At the transitions between two adjacent hologram segments there is a smooth transition in the reflection properties, such that the brightness throughout the resulting partial light distribution, or the light distribution, remains harmonious.

According to one aspect of the invention, the reflection hologram segments that meet at an obtuse angle have a single dedicated light source for generating a partial light distribution, or a light distribution. This advantageously minimizes the number of LEDs, and therefore the amount of electricity needed for the signal function. The reflection hologram segments are preferably integrally joined to one another, resulting in a faceted hologram reflector. Different partial light distributions are obtained with the reflection hologram segments, which are superimposed to obtain a light distribution forming a signal light distribution, e.g. for tail lights, brake lights, turning signals, daytime running lights, reversing lights, or rear fog lights.

According to one aspect of the invention, there are numerous hologram reflectors that are spaced apart from one another, each of which has exactly one dedicated light source. The hologram reflectors are preferably identical, such that the light output or intensity can be easily increased.

According to one aspect of the invention, the reflection hologram segment contains numerous subsidiary hologram elements that are preferably of the same size. These subsidiary hologram elements are relatively small, such that a pixeled reflection hologram segment is generated with dual light information. The subsidiary hologram element contains either diffraction information that reflects the light (bright), or diffraction information that does not reflect the light (dark). The reflection hologram segment is thus composed of numerous subsidiary hologram elements arranged in a matrix, which can generate graphics, symbols, or alphanumerical signals based on their diffraction information.

According to one aspect of the invention, the size of subsidiary hologram elements is in the millimeter range, e.g. 0.7 mm×0.7 mm. This results in a sufficiently high resolution for creating symbols or signals, etc. that are “ingrained” in the reflection hologram segment by corresponding diffraction information.

According to one aspect of the invention, the subsidiary hologram elements can be spaced apart, such that there is empty space between adjacent subsidiary hologram elements that contains no light information or reflective properties, thus generating a dark grid for the graphics or signals generated by the reflection hologram segment. A simple pattern can be advantageously generated therewith.

According to one aspect of the invention, the subsidiary hologram elements contain diffraction information resulting in a gradual dimming of the light distribution, or partial light distribution, toward the edges, such that the light fades out. It is assumed that the subsidiary hologram elements can contain a variety of diffraction information, such that pixels of different brightness are reflected. Advantageously, subsidiary hologram elements of different sizes can also be formed in this manner, such that the number of adjacent subsidiary hologram elements with the same diffraction information changes along one or more directions of the reflection hologram segment.

According to one aspect of the invention, the light sources each have focusing lenses with which differences in the directions of the main axes of the light sources and their reflection hologram segments can be compensated for. This means that the light sources can be placed on a single, flat printed circuit board, and their reflection hologram segments can be placed at different levels, or in different alignments to one another. The reflection hologram segments can be arranged on a planar or curved surface. The focusing lenses not only compensate for the differences in the angles of the main axes of the light sources to the main axes of the corresponding reflection hologram segments, but also collimate the light beams from the LED light sources, which, in accordance with Lambert's emission law, are relatively wide. This improves the effectiveness of the lighting device and reduces the power consumption of the light sources.

According to one aspect of the invention, the reflection hologram segment is glued, laminated, or bonded to a substrate. If the substrate is black, a black panel appearance can be obtained, such that the reflection hologram segment looks dark when the lighting device is switched off. The reflection hologram segments are preferably made of a film that can be securely applied to the substrate.

According to one aspect of the invention, the reflection hologram segment is in a housing and laminated or bonded to a substrate, the outer surface of which is then protected by a cover plate formed on the substrate in an injection molding process. The reflection hologram segment, preferably in the form of a film, is therefore reliably protected between two rigid components, preferably made of plastic.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a lighting device from above according to a first embodiment.

FIG. 2 shows a second embodiment of a lighting device from above that has a flat printed circuit board.

FIG. 3 shows a V-shaped printed circuit board from above according to another embodiment of the invention.

FIG. 4 shows a predefined area of a light distribution.

FIG. 5 shows a first part of a partial light distribution for generating the predefined light distribution.

FIG. 6 shows the addition of two other partial light distributions, which overlap the partial light distributions shown in FIG. 5.

FIG. 7 shows two other partial light distributions in a relatively large vertical angular range.

FIG. 8 shows a superimposing of the partial light distributions shown in FIG. 7 on the partial light distributions shown in FIG. 6, which have a smaller vertical deflection.

FIG. 9 shows a perspective view of a lighting device that has a hologram unit composed of flat reflection hologram segments with a single dedicated light source.

FIG. 10 shows an exemplary illustration of light beams from the lighting device shown in FIG. 9.

FIG. 11 shows another embodiment of the lighting device, which has numerous identical hologram units, shown in FIG. 9, and the single dedicated light sources.

FIG. 12 shows a hologram segment composed of subsidiary hologram elements of the same size in comparison with a homogenous surface of a hologram segment.

FIG. 13 shows an exemplary illustration of a hologram segment with dual lighting information for obtaining a graphic.

FIG. 14 shows a hologram segment in which the subsidiary hologram elements are spaced apart.

FIG. 15 shows a hologram segment in which adjacent subsidiary hologram elements at one edge are dimmed, such that the edge fades out.

FIG. 16 shows a schematic illustration of a lighting device from above, with a focusing lens for the light source.

FIG. 17 shows a mount for the reflection hologram segment according to a first embodiment.

FIG. 18 shows a mount for the reflection hologram segment according to a first embodiment.

FIG. 19 shows a perspective view of a lighting device that has numerous light sources on a single, flat printed circuit board.

FIG. 20 shows the lighting device in FIG. 20 from above.

FIG. 21 shows the lighting device in FIG. 20, in which the light beams from a first light source are illustrated.

FIG. 22 shows the lighting device in FIG. 20 in which the light beams from a second light source are illustrated.

FIG. 23 shows the lighting device in FIG. 20 in which the light beams from a third light source are illustrated.

### DETAILED DESCRIPTION OF THE DRAWINGS

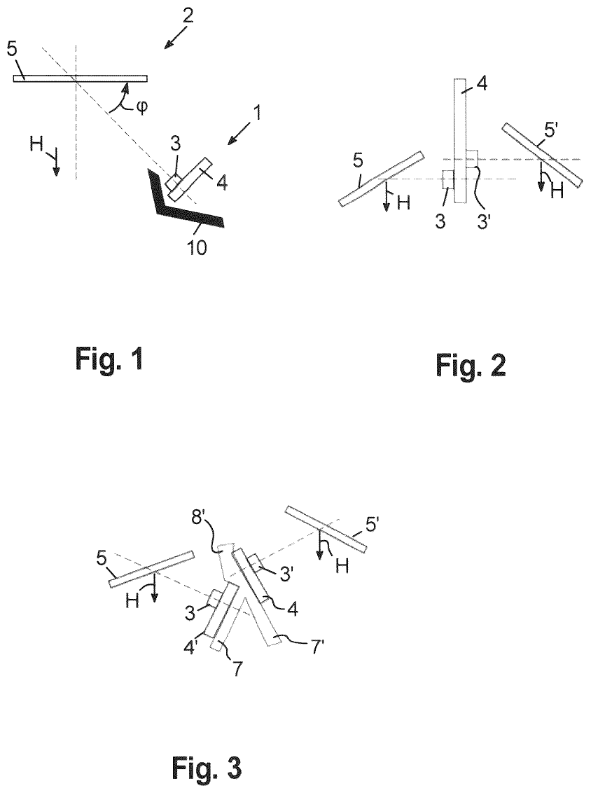

A lighting device for vehicles is shown in FIG. 1 that is used to generate a signal function. It is substantially composed of a light source unit 1 and a hologram unit 2. The light source unit 1 comprises a single light source 3 that is placed on a flat printed circuit board 4. The hologram unit is composed of a hologram element or hologram segment 5 forming a reflection hologram segment. Holographic diffraction information is stored in the reflection hologram segment 5, which results in light emitted from the light source 3, or light striking the reflection hologram segment 5 at an acute angle φ being deflected into the main beam direction H. In this exemplary embodiment, the light 6 emitted from the light source 3 strikes the surface of the reflection hologram segment 5 at an angle of 20° to 70°, preferably 30° to 50°. The main beam direction H is substantially perpendicular to the reflection hologram segment 5. A screen 10 for the light source unit 1 delimits the light emission angle of the light source unit 1 on one side.

According to an alternative embodiment of the invention shown in FIG. 2, there is a first light source 3 on one side of the printed circuit board 4, and a second light source 3′ on the other side, each of which are dedicated to different reflection hologram segments 5, 5′. The reflection hologram segments 5, 5′ are placed on the printed circuit board 4 such that the light emitted from the light sources 3, 3′ strikes the respective hologram segments 5, 5′ at the acute angle φ and is reflected in the main beam direction H. Unlike in the embodiment shown in FIG. 1, the light sources 3, 3′ are not in front of the reflection hologram segments 5, 5′ in the main beam direction H, but to the side thereof.

Identical components and functions have the same reference symbols in the exemplary embodiments.

The printed circuit board 4 in the lighting device shown in FIG. 2 is flat.

Another embodiment of the invention shown in FIG. 3 has a V-shaped printed circuit board substrate 8, on the outside of the first side 7 of which a printed circuit board 4 with a first light source 3 is placed, and on the outside of second side 7′ of which a second printed circuit board 4 with a second light source 3′ is placed. Consequently, the main axes of the light sources 3, 3′ are not transverse to the main beam direction H, but instead are at an acute angle φ thereto, such that the reflection hologram segments 5, 5′ can be placed in a space-saving manner behind the light sources 3, 3′ in the main beam direction H.

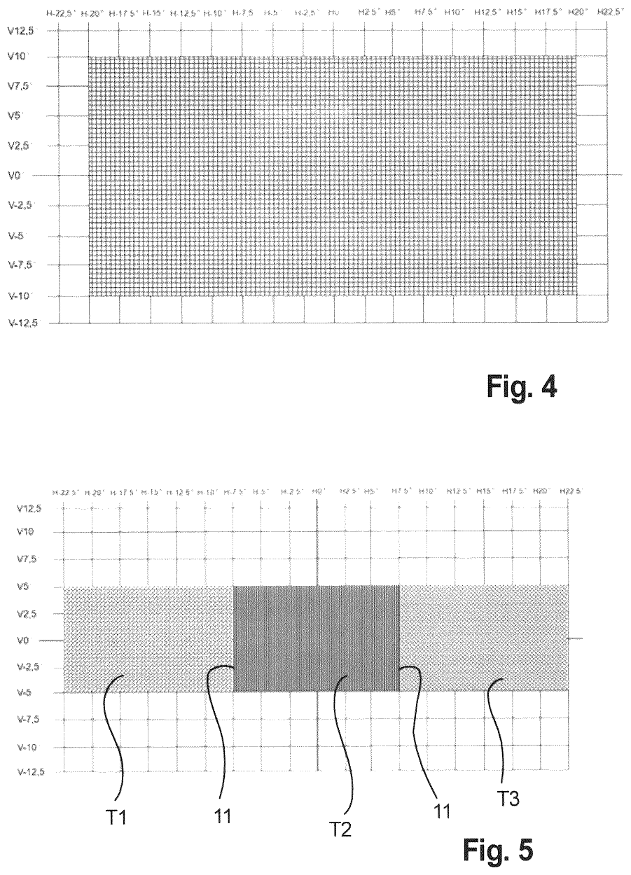

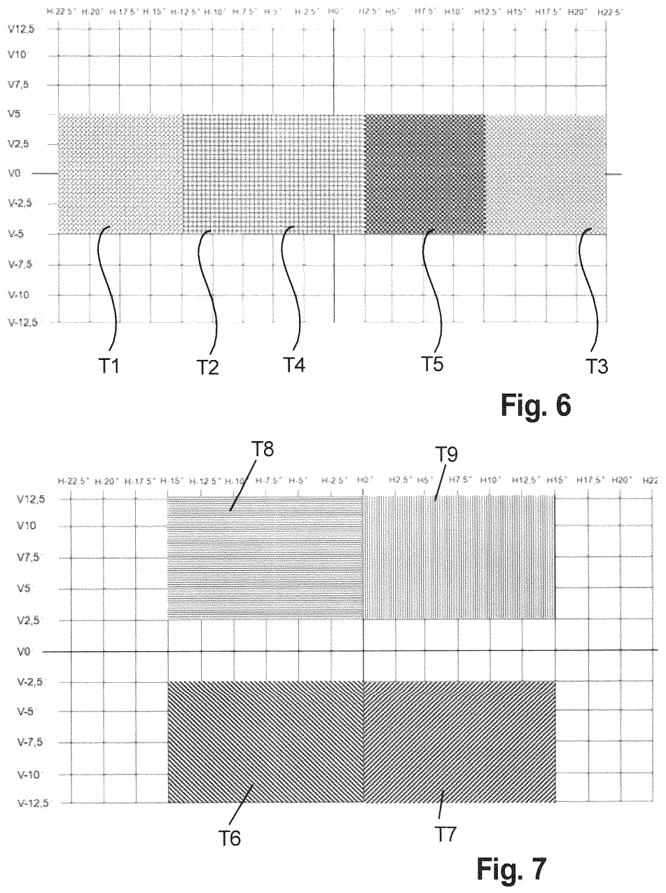

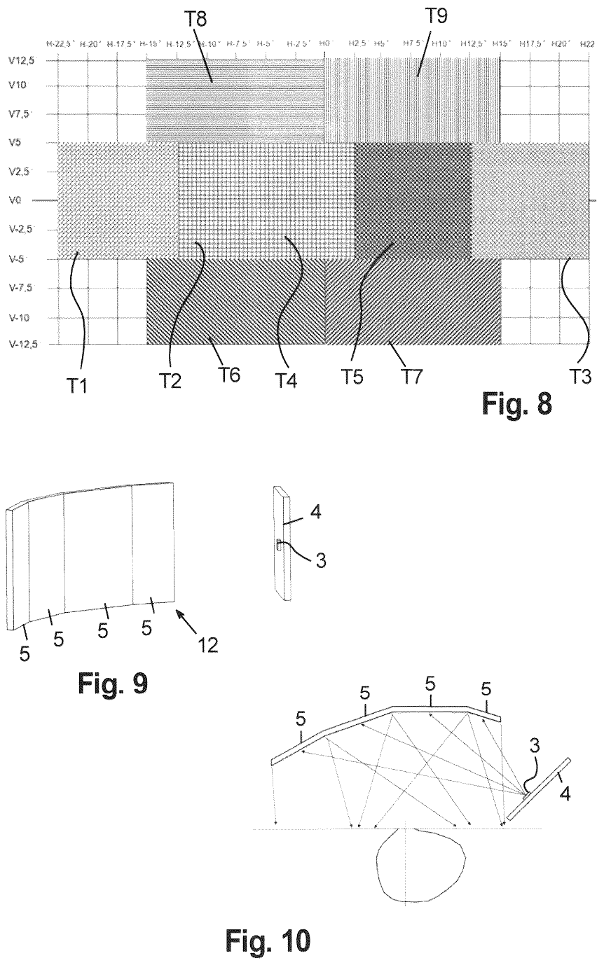

A light distribution for a signal function is shown in FIG. 4, which extends over a rectangular field. In this exemplary embodiment, the light distribution expands horizontally ±20° and vertically ±10°. The light distribution over this predefined angular range in FIG. 4 is formed according to the invention by combining superimposed partial light distributions that overlap one another. Partial light distributions T1, T2, T3 are generated by different reflection hologram segments in FIG. 5, which are the same size (horizontal angle of +7.5°, vertical angle of)+5°, and placed adjacently to one another horizontally. There are boundary lines 11 between partial light distributions T1, T2, T3. Two more partial light distributions T4, T5 are generated by other reflection hologram segments that are not shown, which each have the same vertical expansion of +5° but a smaller horizontal expansion than the partial light distributions T1, T2, T3, such that they overlap them. As shown in FIG. 7, further partial light distributions T6, T7, T8, T9 are generated by corresponding reflection hologram segments, which each have the same horizontal expansion of +7.5° and vertical expansion of +5°, but are offset vertically in pairs. The light distribution shown in FIG. 8 is obtained by superimposing all of these partial light distributions T1, T2, T3, T4, T5, T6, T7, T8, T9, when the reflection hologram segments 5, 5′ that are responsible for these partial light distributions T1, T2, T3, T4, T5, T6, T7, T8, T9 are combined in segments to obtain the overall reflector. The reflection hologram segments are preferably connected integrally to one another.

According to the embodiment of the lighting device shown in FIGS. 9 and 10, a hologram unit 2 is composed of an integral hologram reflector 12, which is composed of four flat reflection hologram segments 5. The hologram reflector 12 has a single dedicated light source 3 on a printed circuit board. The hologram reflector 12 is therefore faceted, and each of the reflection hologram segments 5 provides a different partial light distribution. These partial light distributions are superimposed to obtain the predefined light distribution. The superimposing of these partial light distributions can be overlapping and/or not overlapping.

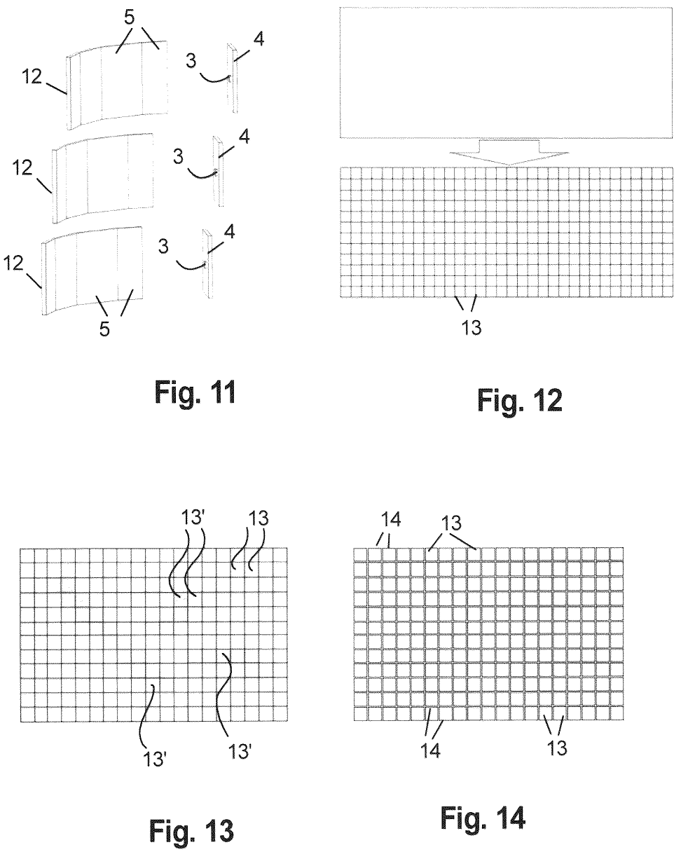

If, for example, brake lights are to be brighter than tail lights, there can be three identical hologram reflectors 12, as is the case in the embodiment shown in FIG. 11, each of which has a single dedicated light source 3. The hologram reflectors 12 each generate the same light distributions.

According to another embodiment of the invention shown in FIG. 12, the hologram reflector 12, or the reflection hologram segment 5 can contain numerous subsidiary hologram elements 13 of preferably the same size, as shown in FIG. 12. These subsidiary hologram elements 13 are arranged in a matrix comprising rows and columns, and are the same size. Each subsidiary hologram element 13 reflects the light 6 from the light source 3 at a predefined angle, such that the light distribution forms a signal.

Numerous subsidiary hologram elements 13 have a dedicated light source 3, which does not need a primary optical element. Misalignment to the main axis of the light source 3 can be compensated for by the lighting and/or diffraction information contained in the respective subsidiary hologram elements 13.

If the beams of a light source 3 dedicated to an adjacent reflection hologram segment 5 strike another reflection hologram segment 5 composed of numerous subsidiary hologram elements 13, the individual subsidiary hologram elements 13 in the reflection hologram segment 5 contain compensation values for this.

The hologram reflectors 12, or the reflection hologram segments 5 can be placed on a flat or curved surface.

The size of the subsidiary hologram elements 13 is in the submillimeter range and/or the micrometer range. In this exemplary embodiment, the subsidiary hologram elements 13 are square, with a surface area of 0.7 mm×0.7 mm.

The hologram reflectors 12, or reflection hologram segments 5, are therefore pixelated, and in the simplest case each subsidiary hologram element 13 contains diffraction information causing it to either reflect or not reflect the light 6. The subsidiary hologram elements 13 therefore contain dual light information, such that they are either bright or dark. As can be seen from FIG. 13, such a hologram reflector 12 can be used to generate a light symbol, when the grey subsidiary hologram elements 13′ in FIG. 13 do not reflect light 6, while the other subsidiary hologram elements 13 do reflect light. The subsidiary hologram elements 13′ therefore form numerous continuous black lines.

Based on the lighting information in the subsidiary hologram elements 13, a symbol and/or an alphanumerical signal can be reflected onto a projection plane in the space inside or outside the lighting device, and displayed there, or displayed on the reflection hologram segment 5 itself, or the hologram reflector 12.

According to another embodiment of the invention shown in FIG. 14, the subsidiary hologram elements 13 can be spaced apart, such that a background grid 14 is formed. The space 14 between the subsidiary hologram elements 13 contains no lighting information and therefore no reflective properties, such that it always remains dark. This results in a dark background grid 14, in which the subsidiary hologram elements 13 can be bright or dark, depending on the lighting information. The subsidiary hologram elements 13 form a matrix or a grid on the surface of the hologram reflector 12, or the reflection hologram segment 5.

According to another embodiment of the invention, not shown in the drawings, the subsidiary hologram elements 13 contain diffraction information with which they can generate more than two different reflection levels. This makes it possible to generate light symbols with lower contrasts.

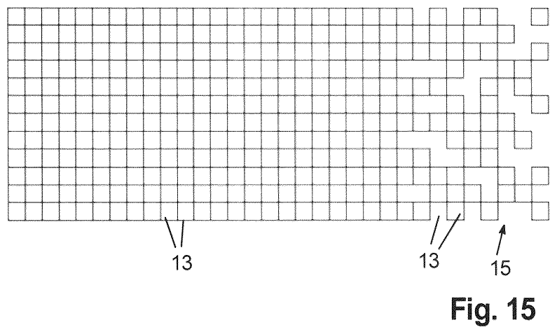

According to another embodiment of the invention, shown in FIG. 15, the subsidiary hologram elements 13 can contain diffraction information or holographic information resulting in a dimming of the edges or an edge of the light distribution, such that the signal light function dims or fades out at the edge.

The numerous subsidiary hologram elements (13, 13′) are directly adjacent to one another in a matrix in this case, i.e. without any empty space therebetween. One or more adjacent subsidiary hologram elements 13′ that contain no holographic information are located near the edge 15 of the hologram reflector 12 or the reflection hologram segment 5, where no light is reflected. This results in a dimming or fading out of the light (6) at the edge of the reflection hologram segment 5 or hologram reflector 12, which affects the light distribution accordingly, if the subsidiary hologram elements 13 reflect the light toward different areas in the light distribution, which is composed of these different areas. The subsidiary hologram elements 13 and 13′ preferably reflect or do not reflect light toward individual areas in the light distribution, which are also arranged in a matrix on a measurement screen.

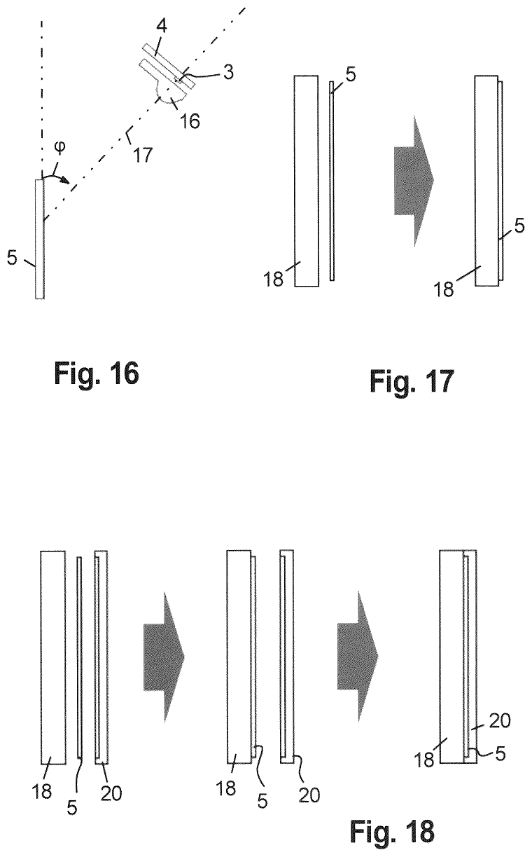

In another embodiment of the lighting device shown in FIG. 16, the light source unit 1 contains both the light source 3 and a focusing lens 16. This focusing lens 16 focuses the light emitted by the light source 3 onto the surface of the reflection hologram element 5. An optical axis 17 of the focusing lens 16 intersects the plane of extension for the reflection hologram segment 5 at an acute angle φ of 20° to 70°, in the exemplary embodiment shown in FIG. 16 at an angle ¢ of 45°.

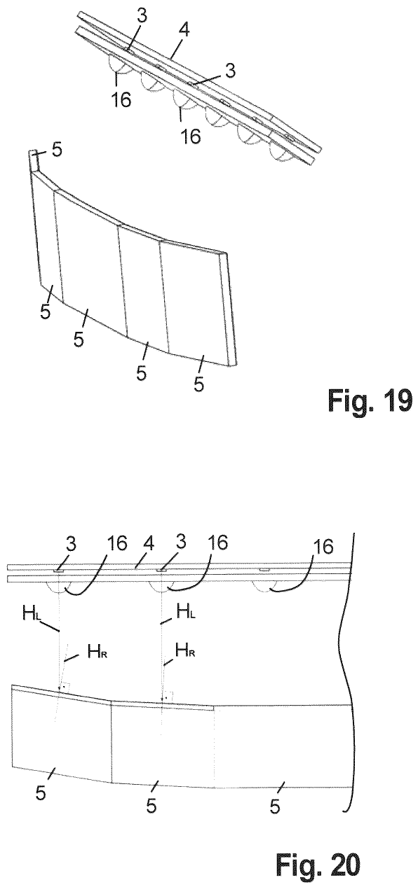

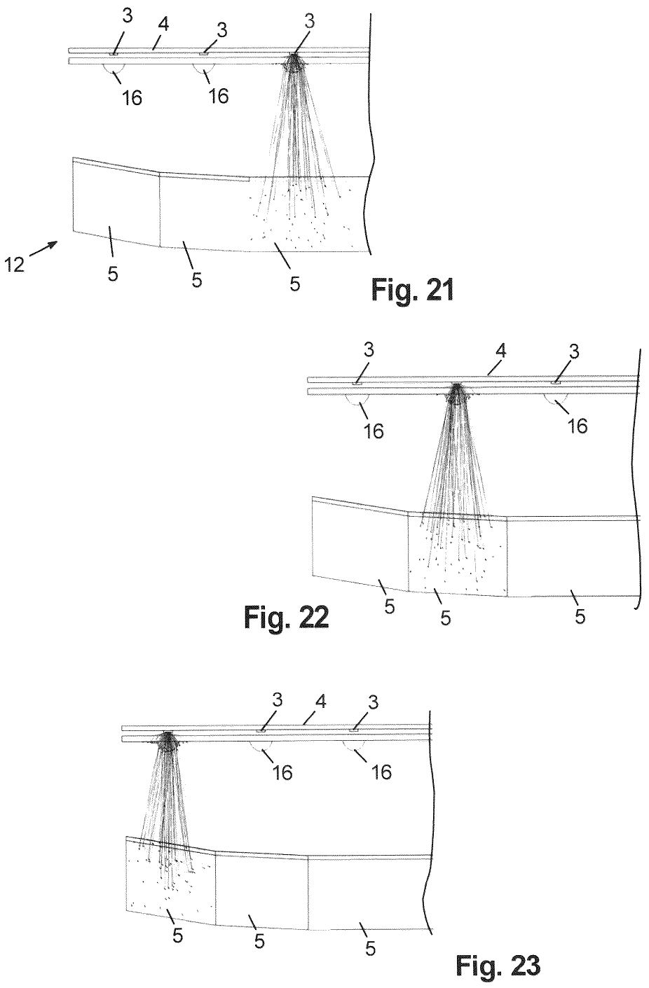

As can be seen from the embodiment shown in FIGS. 19 to 23, the focusing lens 16 for the light source 3 can be used to compensate for differences in the main axes H_{L} of the light sources, which are at acute angles to one another, and the main axes H_{R} of the reflection hologram segments 5. The light sources 3 can be placed on the flat printed circuit board 4, and the focusing lens 16 can direct the light 6 from the light sources 3 such that all of it strikes the reflection hologram segment 5. It can be seen from FIGS. 21 to 23 that each reflection hologram segment 5 is lit by the light 6 from the same dedicated light source 3.

It can be seen in FIG. 17 that the reflection hologram segment 5 can be glued, laminated, or bonded a substrate 18. Alternatively, the reflection hologram segment 5 can be molded to the back thereof.

The reflection hologram segment 5 is preferably a hologram film. If the substrate 18 is black instead of transparent, the lighting device has a black-panel appearance. This means that the lighting device appears to be dark when it is not on.

According to another alternative mounting variation for the reflection hologram segment 5, shown in FIG. 18, the hologram film 5 is protected in a housing 19, which is made of the substrate 18 and a cover plate 20. The hologram film 5 can be laminated or secured to the substrate 18. The substrate 18 can be produced in an injection molding process, and colored black. The cover plate 20 is obtained in a second injection molding process. The cover plate 20 is preferably formed on the inner surface of substrate 18 while the hologram film 5 is held in place thereon.

The substrate 18 is preferably composed of a transparent, black, or white plastic, or a plastic of any color. The front of the cover plate 20 preferably has an antireflective structure or coating. The front of the cover plate 20 is on the side facing away from the reflection hologram segment 5.

The light sources 3, 3′ are preferably LEDs.

### LIST OF REFERENCE SYMBOLS

1 Light source unit
2 hologram unit
3, 3′ light sources
4 printed circuit board
5, 5′ reflection hologram segments
6 light
7, 7′ side
8 printed circuit board substrate
10 screen
11 boundary lines
12 hologram reflector
13, 13′, 13″ subsidiary hologram elements
14 background grid
15 edge
16 focusing lens
17 optical axis
18 substrate
19 housing
20 cover plate
H main beam direction
φ angle
T1-T9 partial light distributions
H_{L}, H_{R} Main axes

1. A lighting device for vehicles, the lighting device comprising:
a light source unit containing a number of light sources; and
a hologram unit containing a number of hologram segments for generating a predefined light distribution,
wherein the hologram segments are reflection hologram segments behind and/or next to the light source unit in a main beam direction (H) of the lighting device, such that light emitted from the light sources strikes the reflection hologram segments at an acute angle (φ), and
wherein holographic diffraction information for generating a signal light distribution is stored in the reflection hologram segments,
wherein the light source unit contains just one printed circuit board or one printed circuit board substrate.

2. The lighting device according to claim 1, wherein the printed circuit board is between at least two reflection hologram segments, wherein the printed circuit board has two sides, on each of which there is at least one light source.

3. The lighting device according to claim 1, further including a V-shaped printed circuit board substrate, the sides of which meet at an acute angle, on the outsides of which the printed circuit boards with the light sources are attached.

4. The lighting device according to claim 1, wherein the reflection hologram segments each contain diffraction information with which partial light distributions are obtained from which the overall predefined light distribution is generated, wherein adjacent partial light distributions overlap and form a signal light distribution.

5. The lighting device according to claim 1, wherein a hologram reflector is composed of numerous reflection hologram segments running in different directions, wherein the adjacent reflection hologram segments meet at an obtuse angle (φ), and the hologram reflector has a single dedicated light source for generating a partial light distribution, or for generating the light distribution.

6. The lighting device according to claim 1, wherein numerous hologram reflectors and their dedicated light sources are spaced apart from one another, wherein the hologram reflectors and/or reflection hologram segments each contain diffraction information for generating a different partial light distribution, from which the predefined light distribution is obtained by superimposing them.

7. The lighting device according to claim 1, wherein the reflection hologram segments or the hologram reflectors contain numerous subsidiary hologram elements, each of which contain diffraction information, such that light is reflected from the respective subsidiary hologram elements in a desired and predefined angular range, and the light distribution for a signal function is obtained.

8. The lighting device according to claim 7, wherein the numerous subsidiary hologram elements are formed such that a symbol and/or alphanumerical signal is reflected onto a projection surface in the space inside or outside the lighting device, or is displayed on the reflection hologram segments or the hologram reflectors.

9. The lighting device according to claim 7, wherein the sizes of subsidiary hologram elements are in the submillimeter range or micrometer range.

10. The lighting device according to claim 7, wherein the subsidiary hologram elements are directly adjacent to one another, or spaced apart from one another, and are arranged in a matrix on the surfaces of the hologram reflectors or the reflection hologram segments.

11. The lighting device according to claim 7, wherein the numerous subsidiary hologram elements are directly adjacent to one another and one or more adjacent subsidiary hologram elements that contain no holographic information are located at an edge of the hologram reflectors or reflection segments, such that no reflection takes place there and the light is faded out or dimmed at these edges of the reflection hologram segments or hologram reflectors.

12. The lighting device according to claim 1, wherein there are numerous light sources on a single, flat, printed circuit board, each light source has a dedicated reflection hologram segment, and each light source has a focusing lens with which the light from the respective light sources is focused onto a surface of their reflection hologram segments, wherein a difference in the angles of the main axes (HL) of the light sources and main axes (HR) of the reflection hologram segments is compensated for.

13. The lighting device according to claim 1, wherein the reflection hologram segments are glued, laminated, or bonded onto a substrate, or molded onto the back thereof.

14. The lighting device according to claim 1, wherein the reflection hologram segments are in a housing, wherein the housing contains a substrate and a transparent cover plate, wherein the transparent cover plate is formed in an injection molding process on the substrate and the reflection hologram segment.

15. The lighting device according to claim 1, wherein the substrate is made of a transparent, black, or white plastic, or a plastic of any color, and a front surface of the cover plate is coatable with an antireflective structure or layer.

16. The lighting device according to claim 7, wherein the numerous subsidiary hologram elements are of the same size.
